(19) United States
(12) Patent Application Publication
(10) Pub. No.: US 2016/0071507 A1
(43) Pub. Date: Mar. 10, 2016

(54) AIR PASSAGE TYPE OR WATER PASSAGE TYPE SOUNDPROOF WALL HAVING ACOUSTIC ISOLATION RESONANCE CHAMBER FORMED IN AIR PASSAGE CHANNEL OR WATER PASSAGE CHANNEL

(71) Applicant: MOKPO NATIONAL MARITIME UNIV., IACF, Jeollanam-do (KR)

(72) Inventor: Sang Hoon KIM, Mokpo (KR)

(73) Assignee: Mokpo National Maritime University Industry- Academic Cooperation Foundation, Mokpo (KR)

(21) Appl. No.: 14/786,562

(22) PCT Filed: Nov. 22, 2013
(86) PCT No.: PCT/KR2013/010664

§ 371 Date: Oct. 23, 2015

(30) Foreign Application Priority Data
Apr. 26, 2013 (KR) 10-2013-0046481

(51) Int. Cl. G10K 11/172; E01F 8/00; E04B 1/84; E04B 1/70; E04B 1/82

(52) U.S. Cl. CPC G10K 11/172; E04B 1/7038; E04B 1/7076; E04B 1/8209; E04B 1/84; E01F 8/0005

(57) ABSTRACT

At least one resonance chamber is disposed around an air passage channel passing through a window or a wall, and the air passage channel and the resonance chamber are separated from each other by a porous sound absorber. When sound and air pass through the air passage channel, the sound is absorbed and cut off by the resonance chambers, and the air passes through the air passage type channel. As a result, an air passage type soundproof window or wall through which the air passes and by which the sound is cut off can be manufactured, and a water passage type soundproof window or wall through which water passes and by which the sound is cut off in the same principle can be manufactured.

### TECHNICAL FIELD

The present invention generally relates to technology for solving an existing problem that cannot achieve both air or water passage and sound isolation in various industrial fields.

If soundproof walls are installed at the sides of a road or a track, sounds as well as air flows are cut off, and ecological isolation obstructing movement of wind, heat, pollen, etc. occurs to have a negative effect on the natural environment

Buildings located at the sides of a road have a problem that noises enter windows when the windows are open and that the buildings are not ventilated when the windows are closed to cut off the noises. Therefore, there is a need to make soundproof windows (or walls) that allow both a passage of air and an interception of noises.

Further, many household electric appliances or industrial machines generate an air flow using a fan for air-cooling (heat-exchange) or supplying hot air in order to realize functions thereof or to secure working reliability or an environment in which each of them is installed. For example, various fans such as a ventilating fan, a fan for cooling a condenser of an air conditioner, a suction fan of a vacuum cleaner, a fan of a hair dryer, and a cooling fan for a heat-generating component in an electronic or mechanical field are used. Since a working noise of a motor or blades is inevitably accompanied in the process of driving the fan, this fan is requested to cut off its working noise but to smoothly supply a wind.

In this way, the present invention can be basically applied to the following: a soundproof wall that needs to pass air while preventing noises of traveling vehicles or trains from spreading out from the sides of a road such as an expressway or a track; a ventilating fan for exchanging indoor air; an outdoor unit (condenser) of an air conditioning system such as an air conditioner; an industrial facility, such as an emissions treatment system such as a cooling tower, or an industrial heat exchange system such as an industrial air conditioner, for which a large heat exchanging fan is used; an air cooling facility for an object radiating hot heat such as an engine; and various household electric appliances such as a vacuum cleaner, a hair dryer, an electric fan, a fan heater, a cooling fan, etc. from which noises of blast blades (a vibration noise caused by shaft eccentricity, a flow noise caused by a flow of air, etc.) according to driving of a motor or working noises of the motor are generated; and moreover, various fields such as a civil engineering and construction field such as a stone pit, a blasting site, or a building or road removal site in which a construction heavy equipment such as a breaker causing a high noise is used when there is a need to smoothly pass air and to cut off noises when being in operation.

In addition, when there is a need to pass water under water, for instance when an ecological environment of aquatic life such as fishes is intended to be protected from noises caused by water or underwater transportation means such as a ship or a submarine or an underwater explosive, a water passage type soundproof wall according to the prevent invention can provide a useful means.

### BACKGROUND ART

The present invention relates to technology in which diffraction and resonance phenomena of a wave are combined. The speed of sound is obtained from a ratio of the intensity of a medium through which a sound passes to an elastic modulus. When a sound passes through an inlet of a resonance chamber, an elastic modulus of the sound has a negative value. Then, a speed, a refractive index, and a wave vector of the sound become imaginary parts, and an amplitude of the sound is exponentially reduced according to an increase in distance. When the resonance chamber is disposed around an air passage channel through which air passes and when a sound having a longer wavelength than a diameter of the air passage channel passes the air passage channel, the sound is spread around by a diffraction phenomenon in the process of passing the air passage channel, and enters the resonance chamber, and is absorbed in the resonance chamber.

Meanwhile, internally known prior arts related to a soundproof wall using a hollow sound absorption block include Korean Unexamined Patent Application Publication No. 10-2013-0010335, filed by Korea Railroad Research Institute and titled “Diffraction noise reduction device for noise barrier upper edge using Helmholtz resonance absorber”, Korean Registered Patent No. 10-1112444, filed by TAECHANG NIKKEI CO., LTD. and titled “Sound absorption block and a fabricated soundproof panel using thereof, and Korean Registered Patent No. 10-1009991, filed by TAECHANG NIKKEI CO., LTD. and titled “Locally reacting panels for sound absorber”. Among them, Korean Registered Patent No. 10-1009991 discloses a technique in which a wide bandwidth of noise is uniformly absorbed to increase a soundproof effect while the noise entering locally reacting inlets of a front plate sequentially passes through locally reacting sound absorption holes of partitions, does not consider an air passing characteristic as in the present invention, and is different in technical spirit from the present invention due to a different structure.

A resonator used in the present invention is a diffraction resonator in which an air passage channel is formed in the center of an empty box in order to maximize diffraction, and is different from a typical Helmholtz resonator having a bottle shape in which a long neck having a mouth is attached to a body having a considerable volume.

### DISCLOSURE

### Technical Problem

Accordingly, the present invention has been made keeping in mind the above problems occurring in the related art, and the present invention is intended to propose an air or water passage type soundproof wall capable of cutting off noises while passing air or water.

### Technical Solution

In order to achieve the above object, according to an aspect of the present invention, there is provided an air or water passage type soundproof wall having a resonance chamber formed around an air or water passage channel, which includes: a tubular sound absorber that includes the air passage channel which has an axis, an effective diameter, and a length, whose leading and trailing ends are open to enable fluid communication with each other, and through which air or water freely passes, and that has a plurality of small holes formed in a surface thereof; and at least one resonance chamber that is formed around an outer circumference of the tubular sound absorber along the axial length of the tubular sound absorber. The resonance chambers are configured such that internal volumes thereof are different from each other.

According to another aspect of the present invention, in the aforementioned configuration, the effective diameter of the air or water passage channel is smaller than a wavelength of a sound approaching the air or water passage channel such that a frequency of the sound is lower than a diffraction frequency of the air or water passage channel.

According to another aspect of the present invention, in the aforementioned configuration, the effective diameter of the air passage channel ranges from 2 cm to 20 cm, or the effective diameter of the water passage channel ranges from 5 cm to 100 cm. As the number of air or water passage channels increases in one resonance chamber, a resonant frequency becomes higher.

According to another aspect of the present invention, in the aforementioned configuration, the axis (A) of the air or water passage channel is perpendicular or oblique with respect to the soundproof wall.

According to another aspect of the present invention, in the aforementioned configuration, the resonance chamber has a volume of 0.1 L to 10 L in air, or a volume of 1.6 L to 250 L in water.

### Advantageous Effects

According to the soundproof wall of the present invention, it is possible to simultaneously achieve ventilation and acoustic isolation.

Since it is possible to simultaneously achieve the ventilation and the acoustic isolation, it is possible to reduce noises entering buildings at the sides of a road while maintaining adequate ventilation.

Since holes are formed in the soundproof wall, a pressure difference across the soundproof wall is small, and thus the soundproof wall does not blow over due to a strong wind. Further, it is possible to reduce an adverse influence of cumulative winds caused by high-speed trains on the soundproof wall.

An object such as an engine generating heat can be well ventilated by air-cooled heat exchange, and thus the noise can be cut off without danger of explosion.

All insects and small birds can freely pass through the soundproof wall of an expressway passing through the heart of the city, and no environmental problems caused by ecological isolation occur.

The soundproof wall is applied to a ventilating fan for exchanging indoor air, an outdoor unit (condenser) of an air conditioning system such as an air conditioner, an industrial facility, such as an emissions treatment system such as a cooling tower, or an industrial heat exchange system such as an industrial air conditioner, for which a large heat exchanging fan is used, and various household electric appliances such as a vacuum cleaner, a hair dryer, an electric fan, a fan heater, a cooling fan, etc. from which noises of blast blades according to driving of a motor or working noises of the motor are generated, so that the working noise can be reduced while exerting a blasting function proper to the machine.

When the acoustic isolation is required in the water while passing water, for instance when an ecological environment of aquatic life such as fishes is intended to be protected from noises caused by water or underwater transportation means such as a ship or a submarine or an underwater explosive, a water passage type soundproof wall according to the prevent invention can provide a useful means

### DESCRIPTION OF DRAWINGS

FIG. 1 is a typical structure view of a resonance chamber for describing a principle of a soundproof wall according to the present invention, wherein FIG. 1(a) illustrates the soundproof wall with a neck length and FIG. 1(b) illustrates the soundproof wall without the neck length.

FIG. 2 is a graph depicting Expression 2.

FIG. 3 is a partly enlarged perspective view of a unit sound absorption block constituting a soundproof wall module used in the test.

FIG. 4 is a longitudinal sectional view of each resonance chamber constituting the unit sound absorption block illustrated in FIG. 3.

FIG. 5 is a view illustrating soundproofing frequency ranges.

FIG. 6 is a graph illustrating frequency-specific transmission losses obtained in real tests of the present invention.

FIG. 7 is a schematic view illustrating a simplified acoustic isolation performance measuring system for the examples.

### MODE FOR INVENTION

Reference will now be made in greater detail to an exemplary embodiment of the present invention, an example of which is illustrated in the accompanying drawings. Wherever possible, the same reference numerals will be used throughout the drawings and the description to refer to the same or like parts.

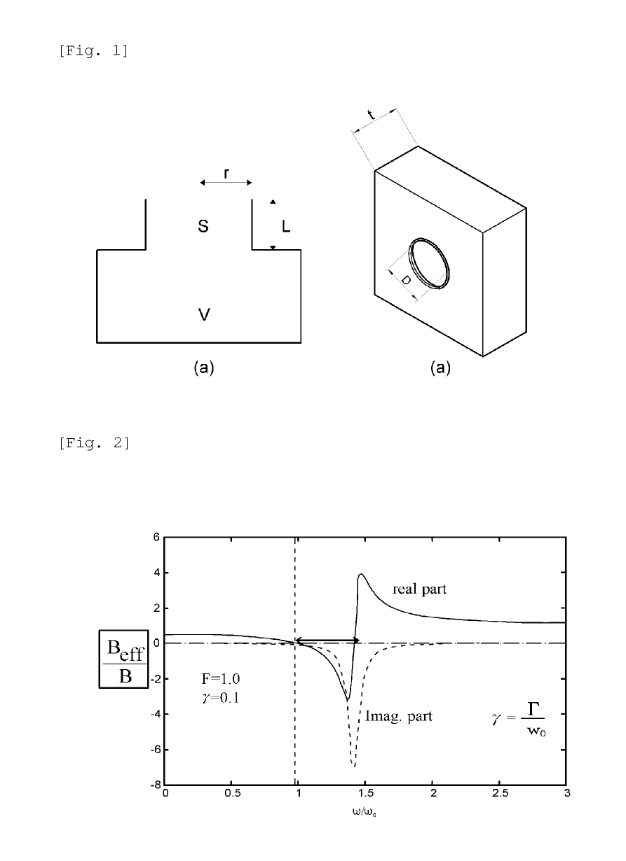

FIG. 1 is a typical structure view of a resonance chamber for describing a principle of a soundproof wall according to the present invention. A unit sound absorption block to which the present invention is applied may be formed in a cylindrical shape or a hexahedral shape. S is an area of an inlet of a resonance chamber, V is a volume of an interior of the resonance chamber, r is a radius of the inlet of the resonance chamber, and L is a length of a neck portion of the resonance chamber.

A speed of sound passing surroundings of the resonance chamber is denoted by a ratio between density and elastic modulus of a medium as in Expression 1 below.

$$v = \sqrt{\frac{Beff}{ρ}} \qquad Expression 1$$

Here ρ is the density of the medium such as air or water, and B_{eff} is the effective elastic modulus of the medium inside the resonance chamber and is denoted as in Expression 2 below when a sound passes through the resonance chamber. FIG. 2 is to graph Expression 2, and is a view illustrating a frequency range in which, when the resonance chamber is disposed and a sound is sent toward the inlet of the resonance chamber, a real part of an effective bulk modulus is negative.

$${B}_{eff}^{- 1} = {B}^{- 1} \{ 1 - \frac{F {ω}_{0}^{2}}{{ω}^{2} - {ω}_{0}^{2} + iΓω} \} \qquad Expression 2$$

Here B is the elastic modulus of the medium outside the resonance chamber and is about 10⁵ Pa in the air, F is a geometrical factor depending on an arrangement way of the resonance chamber, is a value determined by experiment, and is proportional to (volume of resonance chamber)/(volume of air passage channel), Γ is the damping factor whose magnitude becomes smaller in proportion to occurrence of resonance, and ω₀ is the resonant frequency denoted as in Expression 3 below.

$${ω}_{0} = c \sqrt{\frac{S}{{L}^{′} V}} \qquad Expression 3$$

In Expression 3, c is the speed of sound and is about 340 m/sec, S is the area of the inlet of the resonance chamber, V is the volume of the interior of the resonance chamber, and L′ is the effective neck length that is a value obtained by generally adding the radius r of the inlet of the resonance chamber to the neck length L of FIG. 1.

When the inlet of the resonance chamber is not circular, an effective radius r_{eff} when assuming the inlet to be circular is used as in Expression 4 below.

$${r}_{eff} = \sqrt{\frac{S}{π}} \qquad Expression 4$$

However, the resonance chamber of the present invention which is made to maximize diffraction has an air passage channel formed in the center of its body. As illustrated FIG. 1(b), when the resonance chamber is divided into the body and a sound absorber without the neck length, and when a diameter of the air passage channel is defined as D and a depth of the air passage channel is defined as t, an effective neck length L′ is approximately obtained as in Expression 5 below.

L′≃L+1−7r_{eff} Expression 5

An area S of the sound absorber is given as follows.

S=2π(D/2)t=πDt

or

S≡πr_{eff}²

Thus, when the terms S are substituted for each other, the following formula is obtained.

r_{eff}≃\sqrt{Dt}

Therefore, the effective neck length can be obtained by an approximation formula as in Expression 6.

L′≃L+1.7\sqrt{Dt} Expression 6

Here, L is the neck length of the resonance chamber. In the case of a diffractive resonance chamber whose interior is connected to the outside nearly without the neck, the neck length is equivalent to a thickness of the sound absorber. However, when the thickness of the sound absorber is too small compared to the effective radius, the neck length may be ignored.

When L′≃1.7\sqrt{Dt} is substituted for the resonant frequency ω₀, a relation of Expression 7 below is obtained.

$${ω}_{0} = c \sqrt{\frac{S}{{L}^{′} V}} = c \sqrt{\frac{π {r}_{eff}}{1.7 V}} = c \sqrt{\frac{π \sqrt{Dt}}{1.7 V}} \qquad Expression 7$$

Meanwhile, since the speed of sound in the water is about four to five times faster than that in the air, the resonant frequency in the water occurs at a high-frequency range that is about four to five times higher than that in the air. Therefore, since the resonant frequency of the resonance chamber is mainly adjusted by a volume of the resonance chamber, a volume of the resonance chamber in the water should be about 16 to 25 times larger than that in the air in order to cut off the same frequency in the air as in the water. To cut off a frequency, which is cut off in the air by a resonance chamber having a volume of 0.1 L to 10 L, in the water, the resonance chamber should have a volume of 1.6 L to 250 L.

A range in which the effective elastic modulus of the medium inside the resonance chamber is negative when the damping factor is not particularly large in Expression 2 above is given as in Expression 8 or 9.

ω₀<ω<\sqrt{1+F}ω₀ Expression 8

f₀<f<\sqrt{1+F}f₀ Expression 9

In detail, a frequency band equal to or higher than the resonant frequency is cut off, a size of the cutoff range is a geometrical factor and is determined by experiment. As an F value becomes larger, a soundproofing range becomes larger.

When an air passage channel is obliquely formed in the soundproof wall, the same damping effect is produced although the soundproof wall is thin compared to when the air passage channel is horizontally formed. However, when the F value is reduced, the damping frequency range is reduced.

The resonance chamber has multiple resonance modes. Among them, the cutoff band in the equation is the major one at the lowest frequency range. There are many other minor cutoff bands at the higher frequency ranges, too. These minor cutoff bands are also helpful for the soundproofing.

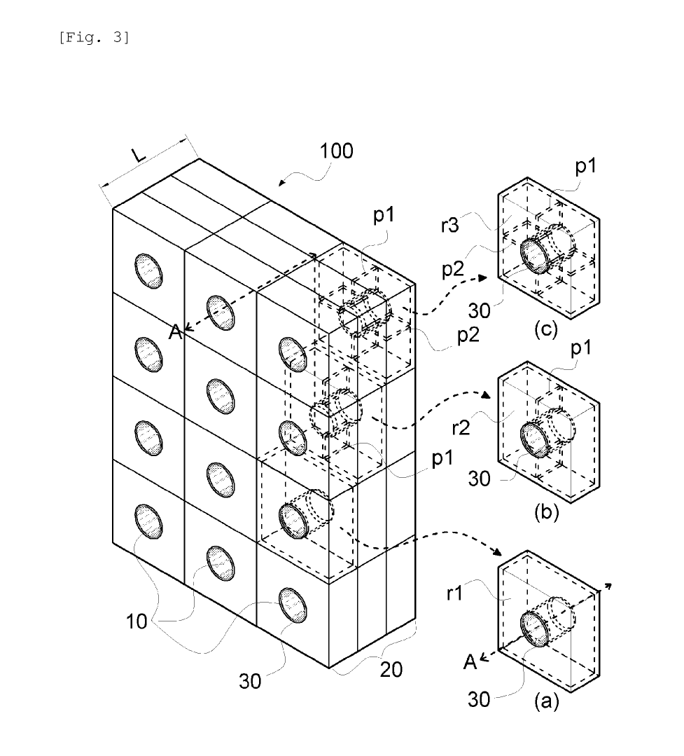

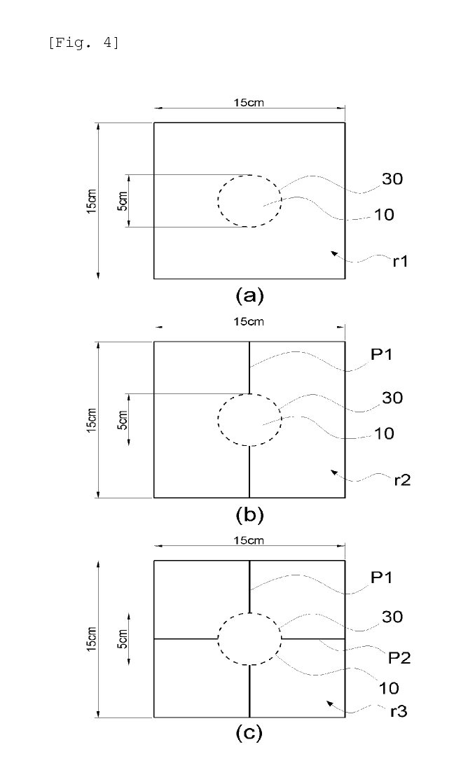

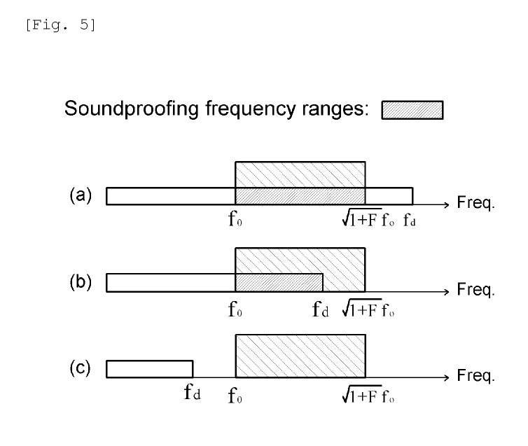

Among soundproof walls having an air passage channel whose diameter is 5 cm as in FIGS. 3 and 4, a soundproof wall (a) has a cutoff frequency band of 600 Hz to 1000 Hz, a soundproof wall (b) has a cutoff frequency band of 1000 Hz to 1600 Hz, and a soundproof wall (c) has a cutoff frequency band of 1400 Hz to 2300 Hz. The range of Expression 9 is a range in which the speed of sound becomes an imaginary part according to Expression 1 and the sound is cut off.

Meanwhile, when the sound is a plane wave, an amplitude is exponentially damped as in Expression 10.

$$A ∝ {e}^{i hz} = {e}^{- ( 2 π \vert n \vert / λ ) z} ≡ {e}^{- hz} \qquad Expression 10$$

When the air passage channel through which air passes is formed in the center of the resonance chamber, a sound passing through the air passage channel is absorbed to the resonance chamber only when causing a diffraction phenomenon. That is, only when the sound approaching (passing through) the air passage channel as in Expression 11 below meets a condition in which a wavelength λ thereof is greater than a diameter D of the air passage channel, i.e. a diffraction condition in which a frequency f thereof is lower than a diffraction frequency f_{d} of the air passage channel, the sound is cut off.

$$f < {f}_{D} \leq \frac{c}{D} \qquad Expression 11$$

Here, f is the frequency of the sound, f_{d} is the diffraction frequency, c is the speed of sound, and D is the effective diameter of the air passage channel. In the underwater case, the speed of sound in the water should be substituted for c. Since the speed of sound in the water is about four to five times faster than that in the air, it is sufficient for the diameter of the air passage channel in the water to be about four to five times greater than that in the air in order to make the same diffraction frequency.

The diffraction frequency f_{d} is given as follows:

$${f}_{D} \leq \frac{c}{D}$$

When the diameter D of the air passage channel is 5 cm, the diffraction frequency in the air is about 6,800 Hz or less.

As diffraction becomes stronger, the sound is spread into the resonance chamber around the air passage channel. As diffraction becomes weaker, the sound travels straight without spreading. For example, when the diameter D of the air passage channel is 5 cm, the diffraction frequency f_{d} is 6,800 Hz (=c/D). However, a strong diffraction effect producing a sound isolation effect of 20 dB or more is effectively shown at a frequency of 2,300 Hz or less that is about one third of the diffraction frequency f_{d} in the case of the diffractive resonator used in this test.

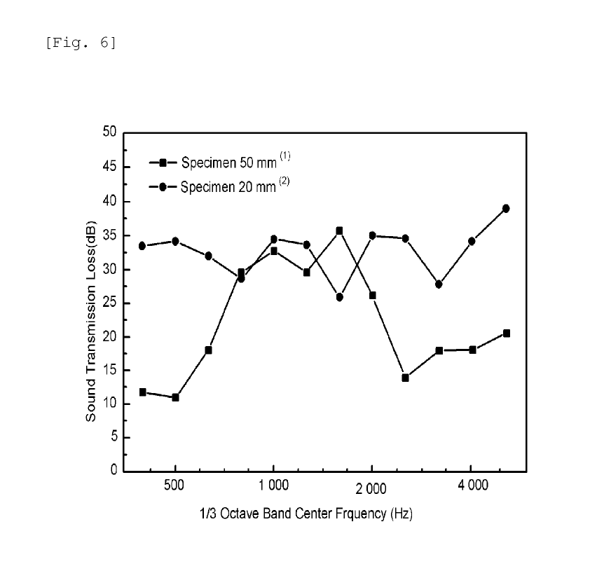

A range in which the resonant frequency of the resonance chamber and the diffraction frequency overlap with each other is the range in which the sound is cut off. FIG. 5 is a view illustrating soundproofing frequency ranges. Portions hatched closely in FIG. 5 are frequency ranges in which the sound is cut off. FIG. 5(a) corresponds to when, since a frequency range from the resonant frequency to the frequency at which the elastic modulus becomes negative is lower than the diffraction frequency, the frequency range is soundproofed as a whole. FIG. 5(b) corresponds to when, since the resonant frequency is lower than the diffraction frequency but the frequency at which the elastic modulus becomes negative is higher than the diffraction frequency, a soundproofing range is reduced. FIG. 5(c) corresponds to when, since the resonant frequency is higher than the diffraction frequency, the frequency range is not soundproofed at all.

Only when the resonance chamber has a large volume, a low frequency can be prevented. Only when the air passage channel has a small diameter, the diffraction frequency can be raised. However, when the diameter of the air passage channel is small, an air passing effect is reduced. Thus, in consideration of requirements of both an air passing characteristic and a soundproofing characteristic according to what a target intended to improve the soundproofing characteristic is, relative specifications including the diameter of the air passage channel and the volume of the resonance chamber can be properly set.

As a material of the resonance chamber in the present invention, any material such as acryl, PVC, glass, wood, metal, or concrete is possible as long as no sound passes through it. The resonance chamber and the air passage channel are separated by the sound absorber.

$$Z = \frac{P}{A} \qquad Expression 12$$

Impedance of the sound absorber is a value obtained by dividing a pressure difference P across the sound absorber by an area A of the sound absorber. The sound absorber includes a variety of porous materials available on the market.

When the impedance of the sound absorber is matched with impedance of an acoustic wave with the volume of the resonance chamber fixed, resonance occurs at a highest frequency. When the impedance of the sound absorber is not matched with the impedance of the acoustic wave, it results in that a part of the acoustic wave is reflected and a sound absorption coefficient is reduced to some degree, but this has an effect of S in Expression 3 increasing or decreasing to be able to change the resonant frequency.

The sound absorber that can be used in the soundproof wall structure according to the present invention includes a variety of porous materials available on the market. For example, an air filter for an air cleaner is a particulate air filter for filtering particulates such as dust and passing only fresh air. According to KS A 0010 (Glossary of terms for contamination control), the air filter for the air cleaner is defined as a filter that has collection efficiency of minimum 90% at a designated face velocity with respect to a maximum passing particle size (typically 0.3). In a test of the present invention which will be described below, an air filter for a vehicle which is a representative example of the air filter for the air cleaner used widely and commercially is used. A material capable of exerting performance equivalent to this air filter includes a sound absorption cloth for an opera theater. Materials such as polyester, polyurethane, paper, or non-woven fabric having small holes of 10 mm or less as well as a metal sheet or glass having small holes of 10 mm or less may be used as the sound absorber of the soundproof wall structure according to the present invention. Due to a diffraction effect, the acoustic wave of the sound passes through the small holes formed in the sound absorber, enters the resonance chamber, causes resonance in the resonance chamber, and is dampened. The sound absorber of the soundproof wall structure according to the present invention is distinguished from a material in which a sound is simply reflected, offset, and cut off.

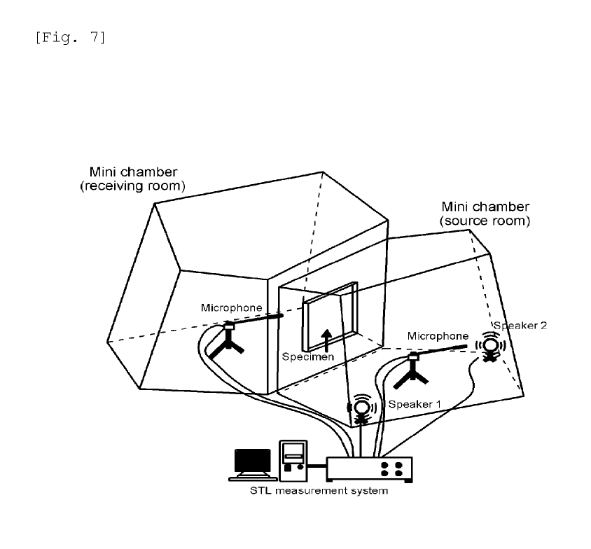

FIG. 6 is a graph illustrating frequency-specific transmission losses obtained in real tests of the present invention. In the case of a graph, for instance, a graph indicating that the effective diameter of the sound absorber is 5 cm; if there are three resonance chambers, three peaks should be detected. However, one peak corresponding to a highest frequency is excluded because it is higher than 2,300 Hz that is an actually detected diffraction frequency, and only the other two peaks are detected. In general, high frequencies are easily cut off because of easy scattering, and low frequencies are rarely cut off because of relatively less scattering.

### EXAMPLE 1

A soundproof wall structure according to the present invention was made with specifications to be described below, and acoustic isolation performance thereof was tested in Korea Institute of Machinery & Materials (KIMM) at 156 Gajeongbuk-Ro Yuseong-Gu Daejeon Korea (test receipt number: system 350-1-12101).

Measurement was a test using a simplified acoustic isolation performance measuring system provided for KIMM, and simplified acoustic isolation performance was measured in a mini chamber on the basis of acoustic isolation performance test standards (ISO 140-3: 1995, ASTM E 90-09: 2009, and KS F 2808: 2001). An outline diagram of the simplified acoustic isolation performance measuring system used in the test is as in FIG. 7.

Measurement conditions were as follows.

(Measurement Conditions)
Effective diameter of air passage channel: 5 cm
Area of specimen: W450 mm×H600 mm
Volume of mini chamber
   Volume of source room: 2.808 m³
   Volume of receiving room: 3.252 m³
Test date: Dec. 11, 2012
Temperature: 27.0° C.
Relative humidity: 47.0% R.H.

(Type of Sound Source and Measurement Position)

Two speakers were used as sound sources, and white noises ware applied at the same time. A sound pressure was measured at a total of 12 measurement positions (six measurement positions for the source room and six measurement positions for the receiving room).

(Configuration of Specimen)

FIG. 3 is a partly enlarged perspective view of a unit sound absorption block constituting a soundproof wall module used in the test, and FIG. 4 is a longitudinal sectional view of each resonance chamber constituting the unit sound absorption block illustrated in FIG. 3.

As can be seen from FIGS. 3 and 4, a soundproof wall 100 according to the present invention was configured as a wall structure having an entire area of W450 mm×H600 mm by stacking unit sound absorption blocks 20, in each of which three resonance chambers r1, r2 and r3 having different volumes were continuously superposed around air passage channels 10 arranged in a horizontal direction (direction of an axis A) in the direction of the axis A, in an array of width three levels and height four levels such that a total thickness of each unit sound absorption block 20 was equal to an axial length (L=12 cm).

Each resonance chamber used to prepare the specimen was made of acryl for the sake of convenience. Width (W)×length (L)×height (H) of each unit sound absorption block 20 was 15 cm×12 cm×15 cm, and width×length×height of the entire soundproof wall 100 was 45 cm×12 cm×60 cm.

A cylindrical portion formed in the center of the unit sound absorption block 20 in the direction of the axis A was the air passage channel 10 partitioned by a porous sound absorber 30. Leading and trailing ends of the air passage channel 10 were openings subjected to fluid communication with each other, and air or water freely passed through the leading and trailing ends. Each of the resonance chambers r1, r2 and r3 and the air passage channel 10 were separated to be able to propagate the sound by the porous sound absorber 30. In the present embodiment, the sound absorber 30 employed a filter for a vehicle air cleaner (cabin activated carbon air filter available from DOOWON HALLA) distributed commercially, and the effective diameter D of the air passage channel 10 was 5 cm.

FIGS. 4(a), 4(b) and 4(c) are longitudinal sectional views illustrating three resonance chambers r1, r2 and r3 that are disposed in the direction of the axis A and have different internal volumes due to partitions p1 and p2 in the unit sound absorption block constituting the soundproof wall structure.

It can be found from FIG. 4(a) that, since no partition is used, an internal space of the resonance chamber r1 formed around an outer circumference of the sound absorber 30 is an undivided single space. It can be found from FIG. 4(b) that an internal space of the resonance chamber r2 is divided into two left and right equal parts by a vertical partition p1 formed among the outer circumference of the sound absorber 30 and top and bottom walls of the resonance chamber r2 and that a volume of each of the two divided resonance chambers is half the volume of the single space resonance chamber r1 illustrated in FIG. 4(a). It can be found from FIG. 4(c) that an internal space of the resonance chamber r3 is divided into four top, bottom, left and right equal parts by vertical and horizontal partitions p1 and p2 formed among the outer circumference of the sound absorber 30 and top and bottom walls of the resonance chamber r3 and among the outer circumference of the sound absorber 30 and left and right walls of the resonance chamber r3 and that a volume of each of the four divided resonance chambers is one fourth of the volume of the single space resonance chamber r1 illustrated in FIG. 4(a).

In this way, the present invention is to increase an acoustic isolation frequency band of the sound as a whole by disposing the plurality of resonance chambers r1, r2 and r3 having different volumes around the outer circumferences of the porous sound absorbers 30, each of which defines a boundary between the air passage channel 10 and the resonance chamber, in a traveling direction (direction of the axis A) of air to be propagated. As the volume of the resonance chamber becomes larger, a low-frequency range of sound is absorbed and dampened. As the volume of the resonance chamber becomes smaller, a high-frequency range of sound is absorbed and dampened. Therefore, in the case of the resonance chamber r1 of FIG. 4(a) which has the undivided single volumetric space, a frequency band to be absorbed is a low frequency band of 600 Hz to 1000 Hz. In the case of the resonance chamber r2 of FIG. 4(b) whose internal space is divided into the two volumetric spaces, the frequency band to be absorbed is a medium frequency band of 1000 Hz to 1600 Hz. In the case of the resonance chamber r3 of FIG. 4(c) whose internal space is divided into the four volumetric spaces and is constituted of smallest volumetric spaces, the frequency band to be absorbed is a high frequency band of 1400 Hz to 2300 Hz.

### EXAMPLE 2

The diameter D of the air passage channel 10 of Example 1 described above is 5 cm. In contrast, Example 2 is configured such that the diameter D of the air passage channel 10 is 2 cm, and the other configurations are identical to those of Example 1 described above.

Table 1 below is a table in which test results of Example 1 described above and Example 2 are arranged, and FIG. 6 is a graph depicting sound transmission losses.

TABLE 1

| | |
|---|---|
| | Sound |
| ⅓ octave band | transmission loss (dB) |

| center frequency | Example 1 | Example 2 |
|---|---|---|
| 400 | 11.8 | 34.2 |
| 500 | 10.9 | 32.0 |
| 630 | 18.0 | 28.7 |
| 800 | 29.5 | 34.6 |
| 1000 | 32.8 | 33.7 |
| 1250 | 29.6 | 26.0 |
| 1600 | 35.8 | 35.1 |
| 2000 | 26.3 | 34.7 |
| 2500 | 14.3 | 28.0 |
| 3150 | 18.2 | 34.3 |
| 4000 | 18.4 | 39.2 |
| 5000 | 20.9 | 27.9 |
| Average | 22.2 | 32.4 |

As generally known, the frequency range that is audible to normal persons ranges from 20 Hz to 20,000 Hz. However, most mechanical sounds have high frequencies of 500 Hz or higher. Considering that the high frequencies above 500 Hz are easily scattered and fail to travel far away and that it will suffice if most soundproof windows or walls cut off a frequency range of 500 Hz to 5,000 Hz, as can be found from Table 1 above, both of the examples are subjected to a sound transmission loss of average 20 dB or more in the frequency range of 400 Hz to 5,000 Hz as a whole. Especially, in the case of the soundproof wall configured as in Example 1, it can be found that an effective cutoff frequency band capable of calculating upon a commercially competitive acoustic isolation effect (20 dB or more) ranges from 700 Hz to 2,300 Hz. It can be found that the soundproof wall configured as in Example 2 can sufficiently achieve a commercially useful (competitive) acoustic isolation effect (20 dB or more) over an entire frequency band of 400 Hz to 5,000 Hz to be cut off.

Meanwhile, in the aforementioned examples, the two cases in which the effective diameter D of the air passage channel 10 is set to 2 cm and 5 cm have been tested. However, it was found that useful acoustic isolation performance can be obtained even when the effective diameter D of the air passage channel 10 is set to 20 cm. If the acoustic isolation is possible when the effective diameter D of the air passage channel 10 is greater than 5 cm, the diffraction condition of FIG. 5 and the elastic modulus condition of the sound should be simultaneously met. For example, when the effective diameter D of the air passage channel 10 is 10 cm, the diffraction condition is

$${f}_{d} < \frac{340 m \text{/} sec}{0.1 m} ( = 3.4 kHz ) .$$

The diffraction frequency having an acoustic isolation effect of 20 dB or more is 1.1 kHz that is ⅓ of this value in the case of the diffractive resonator. Therefore, the acoustic isolation of 20 dB or more is possible only in a frequency range of 1.1 kHz or less. The resonance chamber should have a large volume such that resonance can occur below a diffraction frequency. Similarly, when the effective diameter D of the air passage channel 10 is 50 cm, the diffraction condition is

$${f}_{d} < \frac{340 m \text{/} sec}{0.5 m} ( = 680 Hz ) .$$

The acoustic isolation effect of 20 dB or more can be produced only at a frequency of 230 Hz that is ⅓ of this value. Since the speed of sound in the water is about four to five times that in the air, the diffraction frequency in the water is about four to five times that in the air.

In the aforementioned two examples, the configuration in which the sound absorber 30 is disposed in the center of the unit sound absorption block 20 has been illustrated. However, the sound absorber 30 is not necessarily located in the center of the unit sound absorption block 20. Further, the shape of the air passage channel 10 configured by the sound absorber 30 is not necessarily the cylindrical shape, and may be various tubular shapes such as a quadrangular prismatic shape. In the examples, the material of the resonance chamber is acryl, but any material such as glass, wood, plastic, metal, or concrete can be used as long as it can cut off the sound.

In the aforementioned two examples, the volumes of the plurality of resonance chambers r1, r2 and r3 superposed around the sound absorbers 30 in the horizontal direction (direction of the axis A) in forming the unit sound absorption block 20 are unequally configured in the order of 1, ½ and ¼ when the volume of the resonance chamber r1 is set to 1, but not necessarily limited thereto. For example, if two frequency bands should be cut off, two resonance chambers are superposed. If three frequency bands should be cut off, three resonance chambers are superposed. If the acoustic isolation effect can be obtained to a desired level when the frequency band to be cut off is any specific frequency band, only the resonance chambers having the same volume may be superposed without the resonance chambers having different volumes.

Meanwhile, in the present invention, the air passage channel 10 is configured in a straight line, i.e. such that the axis A of the unit sound absorption block 20 is perpendicular to the soundproof wall, but not necessarily limited thereto. The air passage channel may be configured in a curved or oblique shape. In the case of the curved or oblique air passage channel, the air passing characteristic may be somewhat deteriorated, but there is an advantage in that a soundproof wall structure may be configured to be much thinner than those of the aforementioned examples.

Further, the soundproof wall according to the present invention has been described to have a quadrilateral shape as a whole. However, without being limited thereto, the soundproof wall may have a cylindrical shape (a disc shape), an elliptical shape, or a polygonal shape. This means that it should be understood that the soundproof wall according to the present invention may be configured in various shapes according to the object to be soundproofed (acoustic isolation effect).

Further, the unit sound absorption blocks 20 used for the soundproof wall 100 according to the present invention have been configured such that the 12 unit sound absorption blocks having the same volume are stacked. However, it should be understood that, if necessary, the soundproof wall according to the present invention may be configured to have only one unit sound absorption block 20, and that the soundproof wall 100 may be configured such that the unit sound absorption blocks having different volumes are stacked. Furthermore, the effective diameters D of the air passage channels 10 within each unit sound absorption block 20 constituting the soundproof wall may be configured to be different from each other within a range in which an entire air passing characteristic of the soundproof wall is not damaged (within a range in which required air passing performance is secured). The array of the air passage channels 10 or the unit sound absorption blocks 20 may be configured in various arrays such as a radial array, a honeycomb array, etc. in addition to a lattice array, and this configuration should be understood to be within the scope of the present invention.

Further, a three-dimensional shape of the entire soundproof wall 100 may be configured in a non-plate shape such as an oval shape rather than a plate shape. This has a meaning in that, when an object to be soundproofed has a curved body like a vacuum cleaner or a hair dryer, the non-plate shape may be applied to various shapes corresponding with the curved body.

In addition, the present invention may be configured in a knockdown (detachable) fashion in which the sound absorber 30 in each unit sound absorption block can be decoupled from or coupled to the resonance chamber formed around the sound absorber 30. This knockdown configuration has an advantage in that, when the small holes formed in the sound absorber 30 for diffractive sound absorption is chocked by dust with the lapse of time and thereby the acoustic isolation performance is reduced, only the sound absorber 30 is decoupled, cleaned, and coupled again, or is replaced with a new sound absorber. Further, as described above, the sound absorber having variable impedance (ratio of the pressure difference across the sound absorber to the area of the sound absorber) may be used to change the resonant frequency.

1. An air passage type soundproof wall having a resonance chamber formed around an air passage channel comprising:
a tubular sound absorber (30) that includes the air passage channel (10) which has an axis (A), an effective diameter (D), and a neck length (L) of the resonance chamber, whose leading and trailing ends are open to enable fluid communication with each other, and through which air freely passes, and that has a plurality of small holes formed in a surface thereof; and
at least one resonance chamber that is formed around an outer circumference of the tubular sound absorber (30) along the length (L) of the tubular sound absorber.

2. The air passage type soundproof wall according to claim 1, wherein the effective diameter (D) of the air passage channel (10) is smaller than a wavelength (λ) of a sound approaching the air passage channel such that a frequency (f) of the sound is lower than a diffraction frequency (f_{d}) (f_{d}=C/D, where C is the speed of sound and D is the effective diameter of the air passage channel) of the air passage channel.

3. The air passage type soundproof wall according to claim 1, wherein the effective diameter (D) of the air passage channel (10) ranges from 2 cm to 20 cm.

4. The air passage type soundproof wall according to claim 1, wherein the tubular sound absorber (30) adjusts a resonant frequency by adjusting impedance thereof.

5. The air passage type soundproof wall according to claim 1, wherein the resonance chamber has a volume of 0.1 L to 10 L.

6. A water passage type soundproof wall comprising:
a water passage channel (10) which has an axis (A), an effective diameter (D), and a neck length (L) of the resonance chamber, whose leading and trailing ends are open to enable fluid communication with each other, and through which water freely passes; and
at least one resonance chamber that is formed around an outer circumference of the water passage channel (10) along the a neck length (L) of the resonance chamber of the water passage channel.

7. The water passage type soundproof wall according to claim 6, wherein the effective diameter (D) of the water passage channel (10) ranges from 5 cm to 100 cm.

8. The water passage type soundproof wall according to claim 6, wherein the resonance chamber has a volume of 1.6 L to 250 L.

9. The air passage type soundproof wall according to claim 2, wherein the effective diameter (D) of the air passage channel (10) ranges from 2 cm to 20 cm.

10. The air passage type soundproof wall according to claim 2, wherein the tubular sound absorber (30) adjusts a resonant frequency by adjusting impedance thereof.

11. The air passage type soundproof wall according to claim 2, wherein the resonance chamber has a volume of 0.1 L to 10 L.

12. The water passage type soundproof wall according to claim 7, wherein the resonance chamber has a volume of 1.6 L to 250 L.
